(19) United States
(12) Patent Application Publication
(10) Pub. No.: US 2023/0390026 A1
(43) Pub. Date: Dec. 7, 2023

(54) DENTAL PRINTING SYSTEM WITH A 3-D FILAMENT PRINTING APPARATUS EXCLUSIVELY FOR PRINTING DENTAL DEVICES

(71) Applicant: Renfert GmbH, Hilzingen (DE)

(72) Inventor: Soeren RIEGER, Hilzingen (DE)

(21) Appl. No.: 18/328,370

(22) Filed: Jun. 2, 2023

(30) Foreign Application Priority Data
Jun. 3, 2022 (DE) 20 2022 103 161.4
Aug. 9, 2022 (DE) 20 2022 104 531.3
Oct. 7, 2022 (DE) 10 2022 126 003.8

(51) Int. Cl. A61C 7/00; A61C 9/00

(52) U.S. Cl. CPC A61C 7/002; A61C 9/0053; A61C 13/0004

(57) ABSTRACT

A dental printing system, comprises a 3D filament printing apparatus exclusively for printing dental devices, in particular dental models, impression trays and/or aligners, which 3D filament printing apparatus has a filament reservoir unit for receiving a filament, at least one printing head and a control and/or regulation unit, further comprises a display unit and comprises a computing unit that is configured to convert a CAD file of the dental device into printing instructions and has at least one memory unit, wherein the computing unit is configured, before each printing operation, to check the CAD file for compliance with standard printing conditions, associated with the at least one dental device, for the 3D filament printing apparatus.

### PRIOR ART

The invention relates to a dental printing system, having a 3D filament printing apparatus exclusively for printing dental devices, in particular dental models, impression trays and/or aligners, which 3D filament printing apparatus has a filament reservoir unit for receiving a filament, at least one printing head and a control and/or regulation unit, having a display unit and having a computing unit that is configured to convert a CAD file of the dental device into printing instructions, and which comprises at least one memory unit, according to the preamble of Claim 1.

The object of the invention is in particular to provide a generic device having advantageous operating properties. According to the invention, the object is achieved by way of the features of Claim 1, while advantageous embodiments and developments of the invention may be gathered from the dependent claims.

### Advantages of the invention

The invention proceeds from a dental printing system, having a 3D filament printing apparatus exclusively for printing dental devices, in particular dental models, impression trays and/or aligners, which 3D filament printing apparatus has a filament reservoir unit for receiving a filament, at least one printing head and a control and/or regulation unit, having a display unit and having a computing unit that is configured to convert a CAD file of the dental device into printing instructions and that comprises at least one memory unit.

It is proposed for the computing unit to be configured, before each printing operation, to check the CAD file for compliance with standard printing conditions, associated with the at least one dental device, for the 3D filament printing apparatus. The standard printing conditions are preferably in this case in particular specific to the 3D filament printing apparatus and to the dental device to be printed.

The 3D filament printing apparatus is preferably at least part, preferably a subassembly, of a 3D printer. The 3D filament printing apparatus may in particular comprise the entire 3D printer. The 3D filament printing apparatus is preferably configured for use as part of the 3D printer. The 3D filament printing apparatus, in particular as part of the 3D printer, is preferably configured to exclusively print dental and/or orthopedic dental devices, in particular dental models, impression trays and/or aligners. The dental and/or orthopedic dental devices are in particular exclusively dental models, impression trays and/or aligners. The 3D filament printing apparatus, in particular as part of the 3D printer, is preferably designed to allow a user to select whether a dental model, an impression tray and/or an aligner should be printed, such that the user is able to set just the corresponding digital model of the dental model, of the impression tray and/or of the aligner and the printing operation starts immediately, in particular provided that no error notifications are present. The fact that an object is configured or designed for a particular function is preferably to mean that the object fulfils and/or executes this particular function in at least one application state and/or operating state. An “operating state” should preferably be understood to mean a state of the 3D filament printing apparatus in which the 3D filament printing apparatus is operation-ready for a printing process, in particular is connected to a power grid, preferably in which the display unit of the 3D filament printing apparatus displays something and/or a voltage is present at the control and/or regulation unit.

A “control and/or regulation unit” should be understood to mean in particular a unit having at least one set of control electronics. “Control electronics” should be understood to mean in particular a unit having a processor unit and having a memory unit and having an operating program stored in the memory unit. The control and/or regulation unit is used in particular to control and/or regulate operation of the 3D filament printing apparatus. The control and/or regulation unit is used in particular to control the components of the 3D filament printing apparatus. The control and/or regulation unit is preferably designed to move the filament from a filament reservoir unit to the printing head. The control and/or regulation unit is preferably designed to control and/or to regulate an output of filament from the printing head. The printing head is preferably heatable, with a temperature of the printing head being able to be regulated by way of the control and/or regulation unit. The control and/or regulation unit is preferably designed to move the at least one printing head such that the printing head outputs the filament so as to form the dental device in/on a printing bed, in particular on a printing plate. The printing bed, in particular the printing plate, and/or the printing head are/is preferably designed to be heatable. The 3D filament printing apparatus preferably has a heating unit for heating the printing bed, in particular the printing plate and/or the printing head, which heating unit is in particular connected to the control and/or regulation unit. The control and/or regulation unit is preferably designed to heat the printing bed, in particular the printing plate, and/or the printing head, preferably via the heating unit. The control and/or regulation unit is preferably designed to move the printing bed, in particular the printing plate, in particular during a printing operation. The 3D filament printing apparatus preferably has an actuator unit for moving the printing plate and/or the printing head, which actuator unit is in particular connected to the control and/or regulation unit. The control and/or regulation unit is preferably designed to move the printing bed, in particular the printing plate, and/or the printing head, in particular during a printing operation, preferably via the actuator unit.

A “computing unit” should be understood to mean in particular a unit having an information input, information processing and an information output. The computing unit advantageously has at least one processor, a memory, input and output means, further electronic components, an operating program, regulation routines, control routines and/or computing routines. The components of the computing unit are preferably arranged on a common circuit board and/or advantageously arranged in a common housing. The computing unit is preferably configured to convert a CAD file of the dental device at least substantially autonomously into printing instructions. The computing unit is preferably configured to read the data from the CAD file and to derive therefrom motion paths and/or material depositions of the 3D filament printing apparatus. The CAD file may preferably for example be provided via the memory unit, via a server or an external storage medium. The CAD file is in particular realized as an STL file.

The computing unit is preferably configured to check the CAD file for compliance with standard printing conditions, associated with the at least one dental device, for the 3D filament printing apparatus, wherein the standard printing conditions are in particular both specific to the 3D filament printing apparatus and specific to the dental device to be printed. The standard printing conditions are used in particular to compare compatibility between the 3D filament printing apparatus and the CAD file. The standard printing conditions may be used in particular to check whether the CAD file is able to be printed by way of the 3D filament printing apparatus. An alignment of the model on the printing bed in the CAD file may be checked, for example. It may also be checked for example whether the model of the CAD file is closed. It may furthermore be checked whether the CAD file is defective and for example is not realized completely on the surface, but rather has cavities. The standard printing conditions define in particular guidelines that the CAD file has to meet in order to be printed or to be printable. The standard printing conditions may also additionally contain parameters in accordance with which the CAD file is able to be adapted, depending on the 3D filament printing apparatus and on the dental device to be printed. The standard printing conditions may therefore for example contain a wall thickness of the dental device to be printed, wherein the wall thickness is dependent in particular on the dental device to be printed and on the 3D filament printing apparatus.

The design according to the invention of the dental printing system makes it possible in particular to guarantee advantageous printability of the CAD model. Advantageously uncomplicated and/or intuitive handling may in particular be achieved. A 3D filament printing apparatus that advantageously specializes in dental devices may be achieved. Advantageously quick printing initialization may in particular be achieved.

It is also proposed for the computing unit to be configured, before each printing operation, to check the printing instructions for compliance with standard printing conditions, associated with the at least one dental device, for the 3D filament printing apparatus. The printing instructions are preferably generated by way of a slicer. The computing unit is preferably configured to check the printing instructions for compatibility with the 3D filament printing apparatus. It would also additionally be conceivable for the printing instructions to be checked for errors by way of the computing unit. Errors in the printing instructions may in particular be recognized.

The computing unit is furthermore in particular configured to correct the printing instructions in the event of errors and/or compatibility problems.

It is furthermore proposed for respectively one printing parameter package, in particular in the form of defined values for different printing parameters, to be stored on the memory unit for the printing of each individual dental device, wherein the computing unit is configured to use a printing parameter package depending on a printing job. A printing parameter package, in particular in the form of defined values for different printing parameters, is preferably stored on the memory unit for the printing of dental models. A printing parameter package in the form of defined values for different printing parameters is preferably stored on the memory unit for the printing of impression trays. A printing parameter package in the form of defined values for different printing parameters is preferably stored on the memory unit for the printing of aligners. The printing parameter package for the printing of dental models preferably differs from the printing parameter package for the printing of impression trays in terms of at least one value for at least one printing parameter. The printing parameter package for the printing of dental models preferably differs from the printing parameter package for the printing of aligners in terms of at least one value for at least one printing parameter. The printing parameter package for the printing of impression trays preferably differs from the printing parameter package for the printing of aligners in terms of at least one value for at least one printing parameter. The printing parameter package is in this case adapted in particular with regard to a material, a required surface quality and/or the like. The printing parameter packages preferably comprise for example a filament type, a printing head type, a printing speed, a printing head temperature, a printing bed temperature, an air humidity, a wall thickness of the dental device and/or an alignment of a digital model of the dental device. A 3D filament printing apparatus that advantageously specializes in dental devices may be achieved. Advantageously quick printing initialization may in particular be achieved. The design according to the invention allows easy operation for a person not skilled in the art of printing systems and avoids incorrect settings that might lead to the loss or at least to the impairment of the printing result.

It is furthermore proposed for the computing unit to be designed, in the event of a recognized discrepancy between at least one parameter of the CAD file of at least one dental device and the standard printing conditions for the at least one dental device, to correct or to supplement the CAD file and/or to output a correction suggestion to an operator. The computing unit is preferably configured to process the CAD file autonomously and/or to forward the data in a form corrected by the slicer during processing. The data may in this case both be corrected completely automatically or a correction is authorized by way of a query to the operator. When correcting the CAD file, an alignment of the model may be corrected, for example. As an alternative, it would be conceivable for a base of the model to be changed. It would also be conceivable, during a correction, for example, for the model to be closed when it is defective and/or does not form a closed volume. It would furthermore be conceivable for undercuts to be blocked out automatically by the computing unit, in particular in the slicer software or in a model creator. Blocking out takes place in particular when producing aligner models. In the blocking-out process, relatively large undercuts in the model are in particular blocked out. The blocking-out process in particular avoids excessively high pull-off forces caused by the undercuts. The blocking-out process may possibly be brought about using separate support material that is removed following the production of the aligner on the aligner model. A printing operation with two different filaments would also be conceivable in order to print the blocked-out locations with a special blocking-out filament that is able to be removed subsequently. Advantageously simple operation may thereby in particular be achieved. Advantageously uncomplicated and/or intuitive handling may in particular be achieved. A 3D filament printing apparatus that advantageously specializes in dental devices may be achieved. Advantageously quick printing initialization may in particular be achieved. The design according to the invention allows simple operation for a person not skilled in the art of printing systems.

It would also be conceivable for the computing unit to be designed to optimize the CAD file. The computing unit may in this case optimize the CAD file in particular with regard to a printing time and/or a filament consumption. The computing unit is preferably configured to adapt the CAD file such that the dental device is printed faster on the 3D filament printing apparatus and/or less filament is required for the printing operation.

It is furthermore proposed for the computing unit to be designed, in the event of a recognized discrepancy between at least one parameter of the CAD file and/or the printing instructions of at least one dental device and the standard printing conditions for the at least one dental device, to initiate a color change of the display unit. The display unit preferably forms part of an operator unit of the 3D filament printing apparatus and/or of an operator terminal device. The operating unit preferably has at least one input apparatus that is connected to the control and/or regulation unit. The at least one input apparatus may be a keyboard having at least one button, control knob, switch, controller or the like, a computer mouse, a touchscreen display and/or a lever. The input apparatus is preferably a touchscreen display. The at least one touchscreen display in particular at the same time forms the display unit. A different design of the display unit that appears expedient to a person skilled in the art would however also be conceivable. By way of example, the color change of the display unit may also comprise just subregions of the display unit. It is thus conceivable for example for a colored frame to be displayed in the event of a discrepancy. As an alternative or in addition, it would also be conceivable for the display unit to comprise a status light that for example lights up in the event of a discrepancy. Advantageously intuitive operation of the 3D filament printing apparatus may be achieved. Automated querying of the standard printing conditions for a desired dental model may in particular be initialized. Provision may also be made for interior illumination of the printing space that changes color depending on activity and/or depending on printing status. By way of example, the control and/or regulation unit is designed to indicate error-free printing in the form of green light by way of the display unit, in particular a lighting unit. By way of example, the control and/or regulation unit is designed to indicate defective printing and/or early stoppage of printing in the form of red light by way of the display unit, in particular the lighting unit. By way of example, the control and/or regulation unit is designed to indicate stand-by operation in the form in particular low-frequency flashing, in particular at most 0.2 Hz, by way of the display unit, in particular the lighting unit. Advantageously simple recognition of the operating state of the 3D filament printing apparatus may be achieved.

A display unit of the 3D filament printing apparatus is in particular embodied as a large color display that permits small instructions and the like.

It is additionally proposed for the computing unit to be designed to check the CAD file containing the digital model to be printed of the at least one dental device for data errors. A data error may in particular in this case be the fact that the model of the CAD file is not closed, in particular not based. A data error may in particular also be the fact that the model is not printable, for example because the model does not have a flat substrate and no support material is used. The computing unit is preferably at least configured to check a shape and a polygonal structure of the model stored on the CAD file. Time-consuming and material-consuming printing errors may thereby particularly advantageously be avoided. Advantageously intuitive operation of the 3D filament printing apparatus may be achieved.

It is furthermore proposed for the computing unit to be designed to check whether the CAD file of the at least one dental device is closed or open. The computing unit is preferably designed to check whether the model of the CAD file of the at least one dental device is closed or open. In the event of an open model, closure may for example be offered and/or the model is closed automatically. The model of the CAD file is preferably a surface model that consists of multiple interconnected polygonal surfaces that constitute visible outer surfaces of the dental model. In the case of a non-closed model, the outer surface is in particular not completely closed since no surfaces are provided between individual polygons. The solid body of the model is therefore in particular open. Time-consuming and material-consuming printing errors may thereby particularly advantageously be avoided. Advantageously intuitive operation of the 3D filament printing apparatus may be achieved. The computing unit may be used in particular to perform automatic closure, basing and/or trimming of the model of the CAD file.

It is furthermore proposed for the computing unit to be designed to check whether an alignment of the model to be printed of at least one dental device corresponds to an alignment stored in the standard conditions for the at least one dental device. The computing unit is preferably designed to check whether an alignment of a largest base surface of the model to be printed corresponds to a subsequent resting surface on the printing plate. The computing unit is in particular configured to check whether the model to be printed actually has a resting surface on the printing plate and whether the resting surface on the printing plate corresponds to a base side configured for a printing operation. The model to be printed should in particular preferably be aligned such that a plane of main extent of the model to be printed runs parallel to the printing plate. The model should in particular be aligned/positioned upright flat on the printing plate. In the case of multiple models to be printed at the same time, it should additionally be ensured that the models are free from collision. It is in particular conceivable for the computing unit, in the case of multiple models, to additionally perform a collision check for the models on the printing plate. In this connection, it would be conceivable in particular for the computing unit, in the case of multiple models, to propose a collision-free suggestion for an arrangement to the operator, and for the operator to be able to move the model virtually on the printing plate only laterally and in a manner free from collision. A “plane of main extent” of a structural unit should be understood to mean in particular a plane that is parallel to a largest side surface of a smallest imaginary cuboid that just completely encloses the structural unit and that in particular runs through the central point of the cuboid. Time-consuming and material-consuming printing errors may thereby particularly advantageously be avoided. Advantageously intuitive operation of the 3D filament printing apparatus may be achieved.

It is furthermore proposed for the computing unit to be designed, in the event of a recognized discrepancy between the alignment of the model of at least one dental device and the standard printing conditions for the at least one dental device, to adapt the alignment of the model to the standard printing conditions. To this end, the computing unit is preferably configured to process the CAD model. By way of example, the computing unit may perform automatic orientation of the model during loading. Models rotated by 90 degrees, that is to say models that lie on the dorsal surface, may be rotated automatically so that they “glide in” in parallel on the base surface. The computing unit is in particular configured to place the model automatically and in a manner free from collision on the printing bed and to perform an automatic collision check during the placement. It would also be conceivable in particular for the computing unit to propose a collision-free suggestion to the operator and for the operator to be able to move the model on the printing plate virtually only laterally and in a manner free from collision. The computing unit is configured in particular to place the CAD model flat on the printing plate. Advantageously automated error correction may thereby in particular take place.

Time-consuming and material-consuming printing errors may thereby particularly advantageously be avoided. Advantageously intuitive operation of the 3D filament printing apparatus may be achieved.

It is furthermore proposed for the dental printing system to have an operator unit for operating the computing unit, wherein the computing unit is designed to load the printing parameter package for printing at least one desired dental device based on a user input. An “operating unit” should be understood here to mean in particular a unit that has at least one component that is able to be actuated directly by an operator and that is configured, through actuation and/or through inputting of parameters, to influence and/or to modify a process and/or a state of a unit coupled to the operating unit. The operating unit preferably has at least one input apparatus that is connected, in particular directly, to the computing unit. The at least one input apparatus may be a keyboard having at least one button, a control knob, switch, controller or the like, a computer mouse, a touchscreen display and/or a lever. The input apparatus is preferably embodied as a touchscreen display. The operating unit is preferably coupled to a display unit, in particular to a display unit different from the display unit of the 3D filament printing apparatus. The display unit is preferably designed, in at least one operating state, in particular before or after a printing operation, to display at least three options for dental devices, in particular a dental model, an impression tray and an aligner, on the at least one touchscreen display. Preferably, a user is able to perform the user input by pressing and/or touching one of the options displayed on the at least one touchscreen display. Advantageously intuitive operation of the dental printing system may be achieved. Automated querying of the standard printing conditions for a desired dental model may in particular be initialized.

It is furthermore proposed for the operating unit to be realized separately from the 3D filament printing apparatus. At least the at least one input apparatus is preferably realized separately from an input apparatus of the 3D filament printing apparatus. The 3D filament printing apparatus preferably comprises a separate operating unit. The fact that the operating unit is realized separately from the 3D filament printing apparatus should preferably be understood to mean that the operating unit is realized so as to be separate, in particular mechanically separate, preferably mechanically unconnected, in particular physically separate, from the 3D filament printing apparatus, wherein the operating unit is connected preferably wirelessly to the 3D filament printing apparatus in order to transmit data. The operating unit may have multiple input apparatuses at least one of which is realized separately from the 3D filament printing apparatus. The operating unit is preferably part of an external apparatus, such as in particular an operator terminal device. Advantageous remote control of the 3D filament printing apparatus may be achieved. The 3D filament printing apparatus may preferably be controlled on a separate apparatus, such as in particular an operator terminal device.

It is also proposed for the computing unit to be designed to load the printing parameter package for printing at least one desired dental device based on an, in particular graphical and/or visualized, selection mask in accordance with the at least one desired dental device in a digital model to be printed of the at least one dental device. The computing unit is preferably configured, in at least one operating state, in particular before or after a printing operation, to display at least one graphical and/or visualized selection mask having at least three options for dental devices, in particular a dental model, an impression tray and an aligner, to an operator, in particular via a display unit on the at least one touchscreen display. The computing unit is preferably designed, when a CAD file is read in, in particular by the operator, to query what type of dental device should be printed using the CAD file. The selection mask preferably comprises no more than ten, preferably no more than eight and particularly preferably no more than six selection options at the same time. The selection mask may preferably be used to directly select a desired dental device, with the selection of the dental device preferably requiring no further printing-specific inputs, such as for example printing parameters. It is also conceivable in particular for the selection mask to be of multi-stage design and to have multiple selection levels. Preferably, in the case of a multi-stage selection, each selection level preferably comprises at most eight, particularly preferably at most six options, preferably at most five, preferably at most four selection levels being provided. This makes it possible to provide advantageously fast, simple and intuitive operation of the 3D printing system. Querying complex printer-specific parameters may in particular be dispensed with. The 3D printing system is preferably generally operated in particular by dental technicians, dentists or dental assistants, meaning that complex knowledge of 3D filament printing apparatuses cannot be assumed. The simple, in particular visualized operation may thereby enable advantageously quick understanding of the 3D printing system.

As an alternative or in addition, it would also be conceivable for the section mask to comprise at least one image of the 3D filament printing apparatus and/or of the dental device with multiple input and/or selection fields that are in particular arranged contextually on the image. The input and/or selection fields are in particular arranged so as to correspond to the image or elements of the image. The input and/or selection fields are in particular preferably already preselected and/or prefilled, with in particular only the input and/or selection fields into which an incorrect value has been entered having to be modified. A direct input may therefore in particular take place directly in the image. This makes it possible in particular to save on multiple section levels.

As an alternative or in addition, it would also be conceivable for the computing unit to evaluate the CAD file, in particular to analyze a shape of the model, and already to preselect the options and/or already to prefill the input and/or selection fields depending on the CAD file. The computing unit may in particular recognize what type of dental device the CAD file involves.

It would also be conceivable for the control and/or regulation unit to be designed to check whether a filament type required according to the printing parameter package for the model to be printed of at least one dental device corresponds to a filament type of a filament in a filament reservoir unit. A filament located in the filament reservoir unit, in particular a filament type, is detected before or after being inserted, in particular via a barcode and/or an RFID code. It would be conceivable for the filament to be detected via the camera of an operator terminal device using an app. A “filament type” should preferably be understood to mean in particular a material of the filament and/or a diameter of the filament. The 3D filament printing apparatus is preferably compatible with defined filaments, with different filaments being provided for different applications. An advantageous preliminary check of the filament material may be achieved. Incorrect printing due to an incorrect filament may in particular advantageously be avoided. The printing parameter package, depending on a required filament type for the model to be printed of at least one dental device, may additionally have a scaling factor for the model to be printed in at least one axis, which scaling factor is configured to compensate for a shrinkage behavior of the filament. The scaling factor is preferably used to expand the model to be printed in relation to a CAD model in accordance with the at least one scaling factor in order to compensate for shrinkage of the printed model due to shrinkage of the filament. The scaling factor is used in particular for shrinkage compensation. Slicer software, which provides a settable parameter for material shrinkage compensation, is already known. Appropriate default values are in the low single-figure percent range. The scaling factor of the printing parameter package is in particular adapted specifically to the filament stored in the printing parameter package. The printing parameter package preferably has a separate scaling factor in an X axis, a separate scaling factor in a Y axis and/or a separate scaling factor in a Z axis. The scaling factor in the X axis preferably corresponds to the scaling factor in the Y axis. The scaling factor in the Z axis is preferably lower than a scaling factor in the X axis. The scaling factor is preferably applied automatically via the printing parameter package in a printing operation. This makes it possible in particular to achieve advantageously high accuracy for the model to be printed. It is also proposed for the at least one 3D filament printing apparatus to have at least one filament reservoir unit, wherein the at least one control and/or regulation unit is designed to detect an amount of filament in the at least one filament reservoir unit and to display a remaining amount of filament in the at least one filament reservoir unit via the display unit. The control and/or regulation unit is preferably designed to display the remaining amount of filament in the at least one filament reservoir unit at least temporarily via the display unit, in particular via the touchscreen display. The computing unit may preferably query a filament type of the filament currently located in the filament reservoir unit via the control and/or regulation unit. The computing unit may preferably query a remaining amount of filament in the at least one filament reservoir unit via the control and/or regulation unit. This makes it possible to determine in particular whether the filament is still sufficient for a future printing job. The consumption is preferably determined automatically in the memory unit during the printing operation. This makes it possible to determine whether interruption-free printing is possible, or it is possible to determine a time to the next filament change. A filament change during a printing operation may in particular be avoided. It would also be conceivable for the 3D filament printing apparatus to additionally have means for an automatic filament change.

The filament is arranged in particular in the filament reservoir unit of the 3D filament printing apparatus. The filament is preferably received in the form of rolls. When rolled up, the filament must in particular not go beyond the roll edge and should slide slightly, for example by way of a mounted axle. An integrated, dust-protected version would also be conceivable. This would in particular have the advantage that the filament would always be stored in the warm environment of the 3D filament printing apparatus and would thus have lower residual moisture. A guide for the filament in the printing space is preferably designed to be detachable. In the case of an integrated filament roll holder, a remaining amount of the filament may in particular be monitored constantly. The control and/or regulation unit may preferably communicate with the filament reservoir unit such that a remaining amount is able to be output for example via the display unit or transmitted to the computing unit. Communication with the filament reservoir unit may additionally take place via WLAN and/or an app. Bidirectional transmission of data for preliminary planning and processing may also take place between the computing unit and/or the control and/or regulation unit and the filament reservoir unit.

The filament reservoir unit is in particular embodied as a filament box that is integrated into the 3D filament printing apparatus. The filament may possibly be loaded and unloaded automatically in the filament reservoir unit. It would also be conceivable for filaments to be able to be received in the filament reservoir unit. It would also be conceivable for the filament reservoir unit to be embodied as a separate drying box for the filament, in which drying box the filament is preconditioned. Preconditioning may in this case take place in particular specifically for a current printing job depending on the standard printing conditions. The drying box may in this case have a communication interface for communicating with the computing unit and/or the 3D filament printing apparatus and forward a state of the filament.

It is furthermore proposed for the control and/or regulation unit to be designed to check whether a printing head required according to the printing parameter package, in particular a nozzle of the printing head, for the model to be printed of at least one dental device corresponds to the printing head that is used. The 3D filament printing apparatus is preferably compatible with defined printing heads, with different printing heads, in particular having different degrees of fineness, being provided for different applications. In this case in particular, a nozzle of the printing head is decisive. An advantageous preliminary check of the printing head may be achieved. Incorrect printing due to an incorrect printing head may in particular advantageously be avoided. It is in particular conceivable for two printing heads to be installed directly in the 3D filament printing apparatus in order to avoid frequent filament changes. The control and/or regulation unit is preferably configured to recognize which filament is loaded in the printing head. Two printing heads with different performance may possibly be provided. Automatic printing head assignment depending on the model to be printed may take place. As an alternative or in addition, it would be conceivable for a fast and simple hot-end and nozzle change to be possible, if possible without tools.

It is furthermore proposed for the 3D filament printing apparatus to have a sensor unit that has at least one air humidity and/or filament moisture sensor that is connected to the control and/or regulation unit, wherein the at least one control and/or regulation unit is designed to check whether a measured humidity or moisture corresponds to a value of a predefined humidity or moisture. The sensor unit preferably comprises multiple sensors, at least one of which is implemented as an air humidity and/or filament moisture sensor. This makes it possible in particular to monitor a process reliability. Factors influencing a printing process may in particular be detected and taken into consideration. In this case, it would be conceivable for example, in the event of a humidity or moisture discrepancy, for example to attempt to adapt the humidity or moisture value by controlling ventilation. As an alternative or in addition, it would be also conceivable for example to adapt a printing process by adapting printing parameters to the changed humidity or moisture. As an alternative or in addition, it would also be conceivable to terminate or at least interrupt a printing process in the event of a humidity or moisture value discrepancy. Depending on a filament provided for the printing operation, the standard printing conditions preferably have a setpoint value for an air humidity and/or filament moisture. Different filaments may in particular be processed with different humidities or moistures. A filament moisture is particularly preferred in this case since the moisture of the filament may differ from an air humidity. In this case, it would in particular also be conceivable to measure the moisture of the filament when it is fed in. A filament moisture may in this case be acquired for example by measuring the electrical conductivity of the filament. It would also additionally be conceivable to provide a temperature sensor that detects an ambient temperature. The ambient temperature may in this case also be part of the standard printing conditions, as a setpoint value or setpoint range. A “sensor unit” in this connection should be understood to mean in particular a unit that is configured to record at least one characteristic variable and/or physical property, wherein the recording may take place actively, such as in particular by generating and transmitting an electrical measurement signal, and/or passively, such as in particular by detecting property changes of a sensor component. Various sensor units that appear expedient to a person skilled in the art are conceivable.

It would also be conceivable for the sensor unit to have at least one position sensor that is designed to detect an alignment of a printing plate and that is connected to the control and/or regulation unit, wherein the control and/or regulation unit is configured to monitor an alignment of the printing plate. The position sensor is preferably arranged directly on the printing plate. The position sensor is used in particular to perform a levelling process. However, it would also be conceivable for the position sensor to detect a position of the printing plate in a contact-free manner. An alignment of the printing plate may preferably be checked and possibly adapted to a printing operation. The printing plate may preferably advantageously be easily manually detached and/or stopped in a defined position. The position sensor is used in particular to check the correct printing plate positioning.

It would furthermore be conceivable for the sensor unit to have at least one incorrect-printing sensor that is designed to record at least one dental device currently being printed during printing and that is connected to the control and/or regulation unit, wherein the control and/or regulation unit is designed to recognize relative movements of parts of the at least one dental device currently being recorded in relation to other parts of the at least one dental device currently being recorded, wherein the control and/or regulation unit is designed to stop the printing operation in the event of recognized relative movements. It is thus possible in particular to detect movements of the model in a targeted manner and avoid printing errors. The at least one incorrect-printing sensor is preferably designed as a camera or the like. The at least one incorrect-printing sensor may be designed identically to the at least one stop sensor, in particular be the same component as the at least one stop sensor. The control and/or regulation unit is preferably designed to activate the at least one incorrect-printing sensor when a printing operation starts. The control and/or regulation unit is preferably designed to deactivate the at least one incorrect-printing sensor when a printing operation stops. By way of example, the control and/or regulation unit is designed to output the error notification at least in part as a color change of the lighting unit. By way of example, the control and/or regulation unit is designed to output the error notification at least in part as a notification on at least one display of the display unit and/or on the at least one touchscreen display. It is advantageously possible to achieve early recognition of incorrect printing caused by a filament breakage on the printed model.

It would furthermore be conceivable for the sensor unit to have at least one incorrect-printing sensor that is designed to record the at least one dental device during printing and that is connected to the control and/or regulation unit, wherein the control and/or regulation unit is designed to detect a discrepancy between a shape of the at least one dental device currently being printed and a digital model to be printed of the at least one dental device. The incorrect-printing sensor may furthermore be designed to record at least one dental device currently being printed during printing and that is connected to the control and/or regulation unit, wherein the control and/or regulation unit is designed to output a video of the dental device currently being printed during printing with a time-lapse function via the display unit. By way of example, the control and/or regulation unit may be designed to output a video, with a length of at most 5 min, preferably at most 2 min, of the dental device currently being printed during printing with a time-lapse function via the display unit, preferably on a display, and/or the touchscreen display. This may give an advantageous overview of the printing process.

As an alternative or in addition, it would also be conceivable for the dental printing system to support and/or provide for augmented reality.

It would also be conceivable for the sensor unit to have at least one printing plate sensor that is designed to detect a position of the printing plate and that is connected to the control and/or regulation unit, wherein the control and/or regulation unit is designed to recognize the printing head being removed from the printing plate and/or a sudden movement of the printing plate. The printing plate sensor is preferably configured in particular to sense when the model has no adhesion and printing is performed into the air. In such a case, the printing operation should in particular be stopped. The control and/or regulation unit is preferably designed to recognize the printing head being removed from the printing plate and/or a sudden movement of the printing plate, wherein the control and/or regulation unit is designed to stop the printing operation when a threshold value for the removal of the printing head from the printing plate is dropped below and/or upon recognizing a sudden movement of the printing plate. The control and/or regulation unit is preferably designed to compare a removal of the printing head from the printing plate at any time with a removal of the printing head from the printing plate in relation to a previous removal of the printing head from the printing plate, in particular a previous removal that is always within an identical time interval, and to compare the difference with a threshold value in order to recognize a sudden movement of the printing plate and/or of the printing head. It is advantageously possible to achieve early recognition of a printing error due to a violent action on the 3D filament printing apparatus. It is advantageously possible to stop printing early due to a violent action on the 3D filament printing apparatus. As an alternative or in addition, it would be conceivable in particular for the 3D filament printing apparatus to have a flexible printing bed. It would in particular be conceivable for the printing bed to be designed to be mechanically, pneumatically or electrically deformable. The printing bed may thus for example be deformed in order to discard the printed dental device. The printing bed may to this end for example have a deformable film.

It would furthermore be conceivable for the at least one control and/or regulation unit to be designed to detect an amount of filament in the at least one filament reservoir unit and to display a remaining amount of filament in the at least one filament reservoir unit via the display unit. The control and/or regulation unit is preferably designed to display the remaining amount of filament in the at least one filament reservoir unit at least temporarily via the display unit, in particular via the touchscreen display. It would additionally be conceivable for the control and/or regulation unit to be configured to compare a required amount of filament for a device currently to be printed with a remaining amount of filament.

It is furthermore proposed for the control and/or regulation unit to be designed to output printing progress for at least one dental device via the display unit by way of a progress bar. Advantageously simple recognition of printing progress of the 3D filament printing apparatus may be achieved. The progress bar may for example display individual steps that have already been completed and which steps are still open. As an alternative, the progress bar may also be realized as a percentage display.

It would also be conceivable for the 3D filament printing apparatus to have a labelling unit that is connected to the control and/or regulation unit, wherein the control and/or regulation unit is designed to control and/or to regulate the labelling unit during printing of the at least one dental device so as to label the at least one dental device. The label on the model may be defined and provided in particular directly by way of the computing unit, in particular by way of the slicer, which adapts the CAD model accordingly. The control and/or regulation unit may alternatively be designed to control and/or to regulate the printing head during printing of the at least one dental device so as to label the at least one dental device through recesses on an outer side of the at least one dental device. It is possible to achieve advantageous labelling of the at least one dental device.

It would furthermore be conceivable for the control and/or regulation unit and/or the computing unit to be designed to output a state of a digital model to be printed of the at least one dental device by way of the display unit or further display means via color changes.

It would also be conceivable for the 3D filament printing apparatus to have a housing unit that has at least one infeed air slot on which there is arranged at least one filter element that is designed to be interchangeable. The housing unit preferably delimits at least one printing space of the 3D filament printing apparatus. The housing unit is preferably configured to receive at least the printing head, the printing bed and the control and/or regulation unit of the 3D filament printing apparatus. A door and/or a flap is preferably arranged on the housing unit and may be used to give access to the printing space. It is possible to achieve advantageous protection of the 3D filament printing apparatus against dust at a ventilation point. The 3D filament printing apparatus should in particular be protected externally against dust. Provision may also additionally be made for targeted infeed air channeling in the housing unit. The infeed air in particular must not impinge directly on the model to be printed. Provision may additionally also be made in the printing space for an overpressure that prevents uncontrolled penetration of contaminated outside air. The exhaust air capacity should permit any potential use of exhaust air filters and be controlled via sensors.

It would also be conceivable for the 3D filament printing apparatus to have a housing unit that has at least one pivotable hood unit, by way of which a printing plate is accessible. The hood unit is preferably arranged on an upper side of the housing unit. Advantageous protection of the printing bed may be achieved. A cover fan is preferably arranged in the hood unit. The 3D filament printing apparatus preferably has a sensor unit that has at least one fan sensor that is designed to detect a rotational speed of a cover fan of the housing unit and that is connected to the control and/or regulation unit, wherein the control and/or regulation unit is designed to output a malfunction of the cover fan via the display unit. Overheating of the 3D filament printing apparatus may advantageously be avoided. The pivotable hood unit makes it possible in particular to reliably provide a power supply for the cover fan. As an alternative or in addition, it would also be conceivable for no electrical components to be arranged in the hood unit, meaning that no lines that are connected to the hood unit are required.

As an alternative, it would also be conceivable for just a fan to be provided in a housing base body of the housing unit, such that the fan is able to be hard-wired. The hood unit may in particular be designed to be as flat as possible, as far as a design only as a removable cover. It would furthermore also be conceivable to lay the filament infeed in the housing base body and not in the hood unit.

It would furthermore be conceivable for the 3D filament printing apparatus to have a sensor unit that has at least one fan sensor that is designed to detect a rotational speed of a cover fan of the housing unit and that is connected to the control and/or regulation unit, wherein the control and/or regulation unit is designed to detect a malfunction of the cover fan. The fan sensor should in particular be used to detect a functionality of the cover fan. The control and/or regulation unit may in particular output a notification when the cover fan is not working correctly or is not connected at all. This makes it possible to provide a uniform printing space temperature. It is in particular possible to carry out filament drying by way of the cover fan, in particular by way of the waste heat from the printing space.

It is furthermore proposed for the dental printing system to have an operator terminal device that comprises the computing unit. The operator terminal device preferably additionally comprises the operating unit. In this connection, an “operator terminal device” should be understood to mean in particular an apparatus for direct or indirect communication with an operator. It should preferably be understood to mean in particular an apparatus assigned to an operator. It should preferably be understood to mean in particular a mobile apparatus for communication with an operator. Various operator terminal devices that appear expedient to a person skilled in the art are conceivable, but these should be understood to mean in particular a computer, a smartphone, a tablet PC, a wearable computer, in particular a smartwatch, and/or data glasses, such as in particular AR glasses and/or a peripheral head-mounted display (PHMD). A computer, in particular a PC or laptop, or a tablet computer, is preferred in particular as an operator terminal device. The operator terminal device is preferably connected to the 3D filament printing apparatus directly, such as for example in wired form via a USB or LAN cable or wirelessly via a Bluetooth or direct Wi-Fi connection, or indirectly, such as in particular via a local area network. The operator terminal device and the 3D filament printing apparatus preferably each have a communication unit. A “communication unit” in this context is in particular to mean a unit that is configured to provide in particular wireless communication, in particular a communication connection, to a further apparatus. The communication unit preferably has at least one interface for communication with the further apparatus. A communication unit should preferably be understood to mean in particular a unit that is configured to exchange data. The communication unit in particular has at least one information input and at least one information output. The communication unit preferably has at least two information inputs and at least two information outputs, wherein in each case at least one information input and at least one information output are configured to be connected to physical system, in particular to the operator terminal device and/or to a 3D filament printing apparatus and/or to a router and/or to a server. This should particularly preferably be understood to mean an interface between at least two physical systems, such as in particular between the 3D filament printing apparatus and the operator terminal device. Various communication units that appear expedient to a person skilled in the art are conceivable, but these should be understood to mean in particular a wireless interface, such as for example Bluetooth, WLAN, Zigbee, NFC, RFID, GSM, LTE or UMTS, and/or a wired interface, such as for example a USB port, a CAN bus interface, an RS485 interface, an Ethernet interface, an optical interface, a KNX interface and/or a powerline interface. This in particular makes it possible to provide an advantageously flexible dental printing system. It is in particular possible to provide an advantageously powerful computing unit without in the process entailing high costs for the 3D filament printing apparatus.

Digital assistance functions may additionally be carried out on the operator terminal device. It would also additionally be conceivable for provision to be made for a model creator that is for example part of the software or may be called externally if required. A chatbot may also in particular be integrated into the software. By way of the operator terminal device, in particular when it is designed as a smartphone, it would also be possible in particular to remotely control the 3D filament printing apparatus outside the network via an application.

The invention also proposes a 3D filament printing apparatus of the dental printing system.

The invention furthermore proceeds from a method for producing dental devices, in particular dental models, impression trays and/or aligners, in particular by way of the dental printing device, wherein, in at least one conversion step, a CAD file of the dental device is converted into printing instructions by way of a computing unit, wherein, in at least one transmission step, the printing instructions are transmitted to a 3D filament printing apparatus and wherein the printing instructions are carried out by way of the 3D filament printing apparatus in a printing step and a desired dental device is printed. It is proposed, in at least one checking step, for the CAD file to be checked by way of the computing unit for compliance with standard printing conditions, associated with the at least one dental device, for the 3D filament printing apparatus. Preferably, in the checking step, the CAD file is checked for compliance with standard printing conditions, associated with the at least one dental device, for the 3D filament printing apparatus, wherein the standard printing conditions are in particular both specific to the 3D printing device and specific to the dental device to be printed. The standard printing conditions are used in particular to compare compatibility between the 3D filament printing apparatus and the CAD file. The design according to the invention of the method makes it possible in particular to guarantee advantageous printability of the CAD model. Advantageously uncomplicated and/or intuitive handling may in particular be achieved. Advantageously quick printing initialization may in particular be achieved. The design according to the invention allows simple operation for a person not skilled in the art of printing systems.

It is also proposed, in at least one selection step, for a printing parameter package designed for the printing of the dental device, in particular in the form of defined values for different printing parameters, to be selected and applied by the computing unit depending on a printing job. The printing parameter packages are preferably retrieved from the memory unit, in particular in the form of defined values for different printing parameters. The selection step preferably takes place before a printing operation, wherein at least one graphical and/or visualized selection mask having at least three options for dental devices, in particular a dental model, an impression tray and an aligner, is displayed for selection to an operator, in particular via a display unit on the at least one touchscreen display. In particular, when a CAD file is read in, in particular by the operator, it is queried what type of dental device should be printed using the CAD file. The selection mask preferably comprises no more than ten, preferably no more than eight and particularly preferably no more than six selection options at the same time. The selection mask may preferably be used to directly select a desired dental device, with the selection of the dental device preferably requiring no further printing-specific inputs, such as for example printing parameters. It is also conceivable in particular for the selection mask to be of multi-stage design and to have multiple selection levels. Preferably, in the case of a multi-stage selection, each selection level preferably comprises at most eight, particularly preferably at most six options, preferably at most five, preferably at most four selection levels being provided. This makes it possible to provide advantageously fast, simple and intuitive operation of the 3D printing system. Querying complex printer-specific parameters may in particular be dispensed with. The 3D printing system is preferably generally operated in particular by dental technicians, dentists or dental assistants, meaning that complex knowledge of 3D filament printing apparatuses cannot be assumed.

It is furthermore proposed for the printing instructions to be checked for compatibility with the 3D filament printing apparatus and/or for errors in a further checking step by way of the computing unit. The computing unit may preferably also correct the printing instructions in the case of errors and/or compatibility problems, in particular in an optional correction step. This makes it possible in particular to avoid printing errors. This makes it possible in turn to save working time.

It is also proposed for the method to have a cleaning step in which the filament is cleaned before a printing operation by way of the 3D filament printing apparatus. When printing filaments, it is important for these to be as free from dust and dirt as possible. Since, in dental laboratories, dust may often occur, in particular due to the production steps carried out there such as grinding or cutting, it is essential for the filament either to be stored free from dust or to be cleaned during use. This cleaning may take place inline, that is to say by way of a cleaning unit that is located upstream of the actual melting process and through which the filament is conveyed, for example during printing. The cleaning may take place in particular using cleaning means and materials such as brushes or using scrubbing technology, for example in conjunction with appropriate suction technology and/or deionization in order to avoid electrostatic effects, which may promote the adhesion of dust. This cleaning unit is preferably integrated in the 3D filament printing apparatus, but may also be located upstream, that is to say arranged outside the 3D filament printing apparatus. This makes it possible in particular to achieve an optimum printing result.

The dental printing system according to the invention and/or the 3D filament printing apparatus and/or the method is/are not configured to be restricted here to the application and embodiment described above. In particular, the dental printing system according to the invention and/or the 3D filament printing apparatus and/or the method may have a number of individual elements, components, units and method steps that differs from a number stated herein in order to fulfil a mode of operation described herein. In addition, in the value ranges indicated in this disclosure, values lying within the stated limits should also be considered to be disclosed and able to be used as desired.

### DRAWINGS

Further advantages may be gathered from the following description of the drawings. An exemplary embodiment of the invention is illustrated in the drawings. The drawings, the description and the claims contain numerous features in combination. A person skilled in the art will expediently also consider the features individually and combine them to form appropriate further combinations.

In the drawings:

FIG. 1 shows a schematic illustration of a dental printing system according to the invention having a 3D filament printing apparatus comprising a control and/or regulation unit and having an operator terminal device comprising a computing unit,

FIG. 2 shows a schematic illustration of the 3D filament printing apparatus of the dental printing system having the control and/or regulation unit, having a filament reservoir unit and having a printing head, and

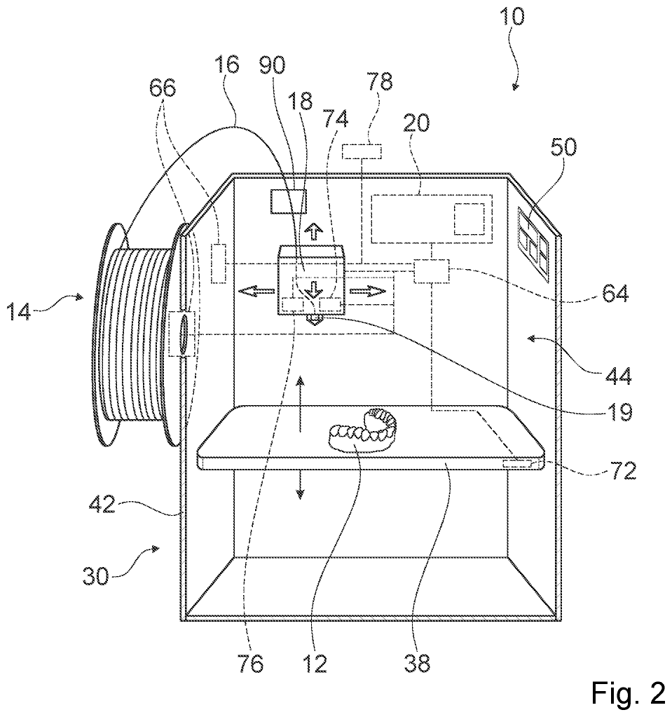

FIG. 3 shows a flowchart of the operation of the dental printing system according to the invention.

### DESCRIPTION OF THE EXEMPLARY EMBODIMENT

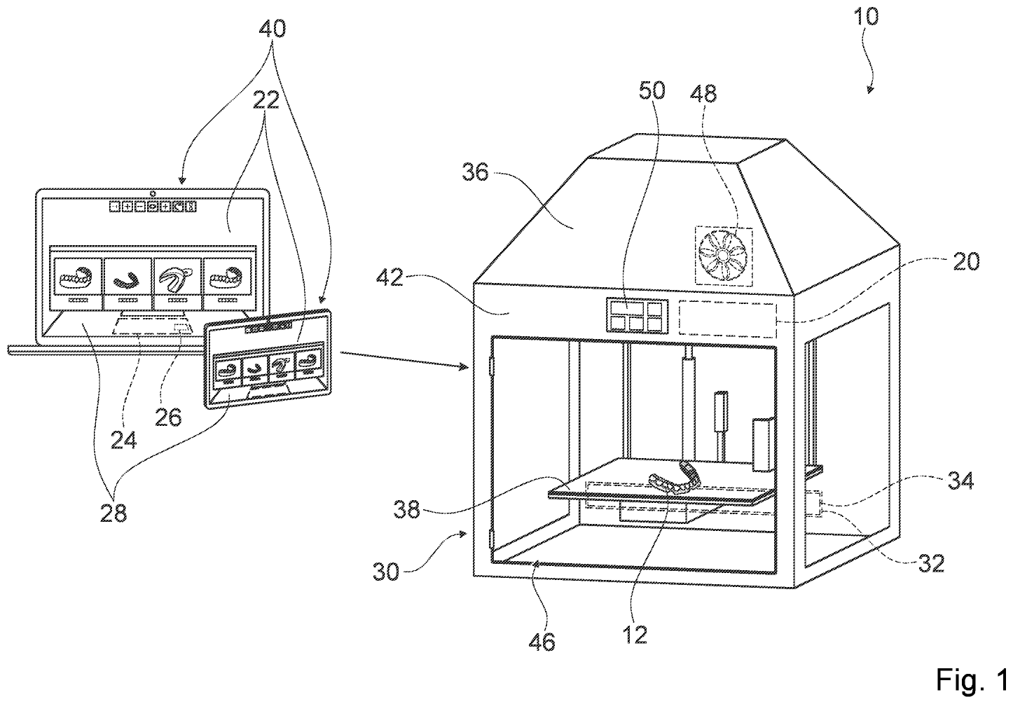

FIG. 1 shows a dental printing system, having a 3D filament printing apparatus 10 exclusively for printing dental devices 12, in particular dental models, impression trays and/or aligners. The 3D filament printing apparatus 10 is configured to exclusively print dental and/or orthopedic dental devices 12. The dental and/or orthopedic dental devices 12 are in this case exclusively dental models, impression trays and/or aligners.

The 3D filament printing apparatus 10 has a housing unit 30. The housing unit 30 comprises an at least roughly rectangular housing 42, which defines a printing space 44 of the 3D filament printing apparatus 10 on at least four sides. The housing unit 30 also has, on a front side, a door 46 via which the printing space 44 may be made accessible. The door 46 is mounted pivotably on the housing 42. The housing unit 30 also has a pivotable hood unit 36, by way of which a printing plate 38 is accessible. The printing plate 38 is accessible via the hood unit 36. The hood unit 36 is arranged on an upper side of the housing 42. The 3D filament printing apparatus 10 also has the printing plate 38. The printing plate 38 is arranged in the printing space 44. The printing plate 38 is mounted so as to be able to move. However, it would also be conceivable for the printing plate 38 to be designed to be fixed relative to the housing unit 30. The printing plate 38 is designed to be height-adjustable, for example by way of an actuator, not visible in any more detail. The printing plate 38 is height-adjustable relative to a base of the housing 42. The printing plate 38 is for example embodied as a rectangular metal plate. The printing plate 38 may be designed to be temperature-controllable.

The housing unit 30 also has at least one infeed air slot 32 on which there is arranged a filter element 34 that is designed to be interchangeable. The infeed air slot 32 is arranged for example in a back wall of the housing 42. A different arrangement of the infeed air slot 32 that appears expedient to a person skilled in the art would however also be conceivable. A fan 48 is arranged in the hood unit 36 and is configured, during operation, to draw in air through the infeed air slot 32, convey it through the printing space 44 and discharge it via the hood unit 36. A different air guidance system that appears expedient to a person skilled in the art would however also be conceivable.

The 3D filament printing apparatus 10 also has a filament reservoir unit 14 for receiving a filament 16. The filament reservoir unit 14 is configured to receive a roll of filament. The roll of filament is mounted in particular interchangeably on a spindle of the filament reservoir unit 14 in a manner not visible in any more detail. During operation, the filament 16 is fed to a printing head 18 of the 3D filament printing apparatus 10 by way of the filament reservoir unit 14. To this end, the filament reservoir unit 14 has a conveying mechanism, not visible in any more detail, which is able to feed the filament 16 to the printing head 18. As an alternative or in addition, it would also be conceivable for the printing head 18 to have a material inlet. The 3D filament printing apparatus 10 has the printing head 18. The printing head 18 is configured to melt the filament 16 and to apply it, preferably to the printing plate 38. The printing head 18 is guided movably relative to the housing unit 30. The printing head 18 is guided movably, via actuators and a rail system by way of example, in a plane parallel to a plane of main extent of the printing plate 38. The printing head 18 may be moved in a defined manner during operation via the actuators. The printing head 18 may for example have a material inlet. The printing head 18 also has a heating unit, in particular a heating coil, and an extrusion nozzle 19. The extrusion nozzle 19 may in this case likewise be designed to be heated. The heating unit is preferably integrated into the extrusion nozzle 19.

The 3D filament printing apparatus 10 also has a control and/or regulation unit 20. The control and/or regulation unit 20 is used to control and/or regulate operation of the 3D filament printing apparatus 10. The control and/or regulation unit 20 is used to control the components of the 3D filament printing apparatus 10. The control and/or regulation unit 20 is designed, during operation, to drive the filament reservoir unit 14 to convey the filament 16 and to feed it to the printing head 18. The control and/or regulation unit 20 is also designed to control and/or to regulate an output of the molten filament 16 from the printing head 18. The control and/or regulation unit 20 in this case additionally controls the temperature of the filament 16 within the printing head 18. The control and/or regulation unit 20 is additionally configured to move the printing head 18 on the basis of printing instructions to produce the dental device 12. The control and/or regulation unit 20 drives the actuators of the printing head 18 for this purpose. The control and/or regulation unit 20 may additionally control the temperature of and move the printing plate 38. The 3D filament printing apparatus 10 also has an operator interface 50, which is for example implemented as a touchscreen display on the housing 42. The operator interface 50 is coupled to the control and/or regulation unit 20. The 3D filament printing apparatus 10 may be operated at least in part via the operator interface 50. The operator interface 50 is realized as an HMI, therefore a human-machine interface.

The dental printing system furthermore has a computing unit 24 that is configured to convert a CAD file of the dental device 12 into printing instructions. The computing unit 24 comprises a memory unit 26 on which respectively one printing parameter package, in particular in the form of defined values for different printing parameters, is stored for the printing of each individual dental device 12. The computing unit 24 is configured to use a printing parameter package depending on a printing job.

The dental printing system also has an operator terminal device 40 that comprises the computing unit 24. The operator terminal device 40 is for example embodied as a laptop or a tablet. When it is designed as a tablet, an application may for example be installed on the operator terminal device 40 and be used as interface for the operator. Different designs of the operator terminal device 40 that appear expedient to a person skilled in the art are however also conceivable. The computing unit 24 is in this case embodied as a processor of the operator terminal device 40.

The dental printing system also has an operating unit 28 for operating the computing unit 24, wherein the computing unit 24 is designed to load the printing parameter package for printing at least one desired dental device 12 based on a user input. The operating unit 28 is realized separately from the 3D filament printing apparatus 10. The operating unit 28 has an input apparatus that is connected directly to the computing unit 24. The input apparatus is realized for example as a keyboard and/or a touchpad of the operator terminal device 40. As an alternative or in addition, the input apparatus may however also be realized as a computer mouse, a touchscreen display and/or a lever. If the operator terminal device 40 is designed as a tablet, the input apparatus is in particular realized as a touchscreen display. The dental printing system furthermore has a display unit 22. The operating unit 28 is coupled to the display unit 22. The display unit 22 is realized as a display of the operator terminal device 40. The display unit 22 is at least designed, in at least one operating state, in particular before or after a printing operation, to display at least three options for dental devices 12, in particular a dental model, an impression tray and an aligner, wherein a user performs the user input by clicking and/or touching one of the options displayed on the display unit 22.

The computing unit 24 is designed to load the printing parameter package for printing at least one desired dental device 12 based on an, in particular graphical and/or visualized, selection mask in accordance with the at least one desired dental device 12 in a digital model to be printed of the at least one dental device 12. The computing unit 24 is configured, in at least one operating state, before or after a printing operation, to display a graphical and/or visualized selection mask having three options for dental devices 12, in particular a dental model, an impression tray and an aligner, for selection to an operator via the display unit 22. The computing unit 24 is designed, when a CAD file is read in by the operator, to query what type of dental device 12 should be printed using the CAD file. The selection mask may be used to directly select a desired dental device 12, with the selection of the dental device 12 requiring no further printing-specific inputs, such as for example printing parameters. A printing parameter package is loaded by way of the selection.

The computing unit 24 is also configured, before each printing operation, to check the CAD file for compliance with standard printing conditions, associated with the at least one dental device 12 that is currently supposed to be printed, for the 3D filament printing apparatus 10. The computing unit 24 is configured to check the CAD file for compliance with standard printing conditions, associated with the at least one dental device 12, for the 3D filament printing apparatus 10, wherein the standard printing conditions are both specific to the 3D filament printing apparatus 10 and specific to the dental device 12 to be printed. The standard printing conditions are used to compare compatibility between the 3D filament printing apparatus 10 and the CAD file. The standard printing conditions may be used to check whether the CAD file is able to be printed. The computing unit 24 is designed, in the event of a recognized discrepancy between at least one parameter of the CAD file of at least one dental device 12 that is currently supposed to be printed and the standard printing conditions for the at least one dental device 12, to correct or to supplement the CAD file and/or to output a correction suggestion to an operator. The computing unit 24 is in this case configured to process the CAD file autonomously and/or to forward the data in a form corrected by the slicer during processing. The data may in this case both be corrected completely automatically or a correction is authorized by way of a query to the operator. The computing unit 24 is also designed, in the event of a recognized discrepancy between at least one parameter of the CAD file and at least one dental device 12 and the standard printing conditions for the at least one dental device 12, to initiate a color change of the display unit 22. By way of example, the color change of the display unit 22 may also comprise just subregions of the display unit 22. It is thus conceivable for example for a colored frame to be displayed in the event of a discrepancy. As an alternative or in addition, it would also be conceivable for the display unit 22 to comprise a status light that for example lights up in the event of a discrepancy.

The computing unit 24 is designed to check the CAD file containing the digital model to be printed of the at least one dental device 12 that is currently supposed to be printed for data errors. Data errors may in this case be the fact that the model of the CAD file is not closed, in particular not based. Data errors may also be the fact that the model is not printable, for example because the model does not have a flat substrate. The computing unit 24 is configured to check a shape and a polygonal structure of the model stored on the CAD file. The computing unit 24 is additionally designed to check whether the CAD file of the at least one dental device 12 that is currently supposed to be printed is closed or open. The computing unit 24 is in this case designed to check whether the model of the CAD file of the dental device 12 is closed or open. In the event of an open model, closure may for example be offered and/or the model is closed automatically. The model of the CAD file is a surface model that consists of multiple interconnected polygonal surfaces that constitute visible outer surfaces of the dental model. In the case of a non-closed model, the outer surface is in particular not completely closed since no surfaces are provided between individual polygons. The solid body of the model is therefore open.

The computing unit 24 is furthermore designed to check whether an alignment of the model to be printed of at least one dental device 12 corresponds to an alignment stored in the standard conditions for the at least one dental device 12. The computing unit 24 is designed to check whether an alignment of a largest base surface of the model to be printed corresponds to a subsequent resting surface on the printing plate 38. The computing unit 24 is in this case configured to check whether the model to be printed actually has a resting surface on the printing plate 38 and whether the resting surface on the printing plate 38 corresponds to a base side configured for a printing operation. The model to be printed should preferably be aligned such that a plane of main extent of the model to be printed runs at least substantially parallel to the printing plate 38 and the model to be printed lies flat on the printing plate 38. The computing unit 24 is designed, in the event of a recognized discrepancy between the alignment of the model of at least one dental device 12 and the standard printing conditions for the at least one dental device 12, to adapt the alignment of the model to the standard printing conditions. To this end, the computing unit 24 is configured to process the CAD model. By way of example, the computing unit 24 may perform automatic orientation of the model during loading. Models rotated by 90 degrees, that is to say models that lie on the dorsal surface, may be rotated automatically so that they “glide in” in parallel on the base surface. The computing unit 24 is configured to place the model automatically and virtually and in a manner free from collision on the printing plate 38 and to perform an automatic collision check during the placement. It would also be conceivable for the computing unit 24 to propose a collision-free suggestion to the operator and for the operator to be able to move the model on the printing plate virtually only laterally and in a manner free from collision. The computing unit 24 is configured to place the CAD model flat on the printing plate 38.

The computing unit 24 is additionally configured, before each printing operation, to check the printing instructions for compliance with standard printing conditions, associated with the at least one dental device 12, for the 3D filament printing apparatus 10. The printing instructions are generated from the CAD model by the computing unit 24, in particular a slicer executed on the computing unit 24, following clearance of the CAD model by the computing unit 24. The computing unit 24 is configured to check the printing instructions for compatibility with the 3D filament printing apparatus 10. The computing unit 24 is also designed, in the event of a recognized discrepancy between at least one parameter of the printing instructions of at least one dental device 12 and the standard printing conditions for the at least one dental device 12, to initiate a color change of the display unit 22.

The control and/or regulation unit 20 is designed, during operation, to check, in particular after a selected printing parameter package has been transmitted to the 3D filament printing apparatus 10, whether a filament type required according to the printing parameter package for the model to be printed of at least one dental device 12 corresponds to a filament type of a filament 16 in the filament reservoir unit 14. The control and/or regulation unit 20 is also designed to detect an amount of filament 16 in the at least one filament reservoir unit 14 and to display a remaining amount of filament 16 in the at least one filament reservoir unit 14 via the display unit 22. The control and/or regulation unit 20 is in this case designed to display the remaining amount of filament 16 in the filament reservoir unit 14 temporarily via the display unit 22, in particular before a printing operation, so that it is possible to check whether there is sufficient filament 16. The computing unit 24 may preferably query a filament type and a remaining amount of the filament 16 currently located in the filament reservoir unit 14 via the control and/or regulation unit 20. The control and/or regulation unit 20 is coupled to a sensor unit 64, by way of which the filament reservoir unit 14 is able to be monitored. The sensor unit 64 is preferably also used to monitor the printing head 18 and the printing plate 38.

The control and/or regulation unit 20 is also designed to check whether a printing head 18 required according to the printing parameter package for the model to be printed of at least one dental device 12 corresponds to the printing head 18 that is used. The 3D filament printing apparatus 10 is compatible with defined printing heads 18, with different printing heads 18, in particular having different degrees of fineness, being configured for different applications. An advantageous preliminary check of the printing head 18 currently being used may be achieved.

The 3D filament printing apparatus 10 has the sensor unit 64. The sensor unit 64 has a multiplicity of sensors that are configured to monitor a printing process. The sensor unit 64 has an air humidity and/or filament moisture sensor 66 that is connected to the control and/or regulation unit 20, wherein the at least one control and/or regulation unit 20 is designed to check whether a measured humidity or moisture corresponds to a value of a predefined humidity or moisture. In this case, it would be conceivable for example, in the event of a humidity or moisture discrepancy, for example to attempt to adapt the humidity or moisture value by controlling ventilation. As an alternative or in addition, it would be also conceivable for example to adapt a printing process by adapting printing parameters to the changed humidity or moisture. As an alternative or in addition, it would also be conceivable to terminate or at least interrupt a printing process in the event of a humidity or moisture value discrepancy.

The sensor unit 64 also has a stop sensor 72 that is designed to detect an alignment of the printing plate 38 and that is connected to the control and/or regulation unit 20, wherein the control and/or regulation unit 20 is configured to monitor an alignment of the printing plate 38. The stop sensor 72 is arranged directly on the printing plate 38. However, it would also be conceivable for the stop sensor 72 to detect a position of the printing plate 38 in a contact-free manner. The control and/or regulation unit 20 may check the alignment of the printing plate 38 by way of the stop sensor 72 and possibly adapt it to a printing operation.

The sensor unit 64 furthermore has an incorrect-printing sensor 74 that is designed to record at least one dental device 12 currently being printed during printing and that is connected to the control and/or regulation unit 20, wherein the control and/or regulation unit 20 is designed to recognize relative movements of parts of the at least one dental device 12 currently being recorded in relation to other parts of the at least one dental device 12 currently being recorded, wherein the control and/or regulation unit 20 is designed to stop the printing operation in the event of recognized relative movements. It is thus possible to detect movements of the model in a targeted manner and avoid printing errors. The incorrect-printing sensor 74 is designed as a camera or the like. The incorrect-printing sensor 74 is also designed to record a dental device 12 during printing, wherein the control and/or regulation unit 20 is designed to detect a discrepancy between a shape of the at least one dental device 12 currently being printed and a digital model to be printed of the at least one dental device 12. The incorrect-printing sensor 74 may furthermore monitor at least one dental device 12 currently being printed during printing, wherein the control and/or regulation unit 20 is designed to output a video of the dental device 12 currently being printed during printing with a time-lapse function via the display unit 22. By way of example, the control and/or regulation unit 20 may be designed to output a video, with a length of at most 5 min, preferably at most 2 min, of the dental device 12 currently being printed during printing with a time-lapse function via the display unit 22.

The sensor unit 64 additionally has a printing plate sensor 76 that is designed to detect a position of the printing plate 38 and that is connected to the control and/or regulation unit 20, wherein the control and/or regulation unit 20 is designed to recognize the printing head 18 being removed from the printing plate 38 and/or a sudden movement of the printing plate 38. The printing plate sensor 76 is configured to sense when the model has no adhesion and printing is performed into the air. In such a case, the printing operation should be stopped. The control and/or regulation unit 20 is furthermore designed to recognize the printing head 18 being removed from the printing plate 38 and/or a sudden movement of the printing plate 38, wherein the control and/or regulation unit 20 is designed to stop the printing operation when a threshold value for the removal of the printing head 18 from the printing plate 38 is dropped below and/or upon recognizing a sudden movement of the printing plate 38.

The sensor unit 64 also has a fan sensor 78 that is designed to detect a rotational speed of the fan 48 of the housing unit 30 and that is connected to the control and/or regulation unit 20, wherein the control and/or regulation unit 20 is designed to detect a malfunction of the fan 48.

The control and/or regulation unit 20 is furthermore designed to output printing progress for at least one dental device 12 via the display unit 22 by way of a progress bar. The progress bar may for example display individual steps that have already been completed and which steps are still open. As an alternative, the progress bar may also be implemented as a percentage display.

It would also be conceivable for the 3D filament printing apparatus 10 to have a labelling unit that is connected to the control and/or regulation unit 20, wherein the control and/or regulation unit 20 is designed to control and/or to regulate the labelling unit during printing of the at least one dental device 12 so as to label the at least one dental device 12. The label on the model may be defined and provided in particular directly by way of the computing unit 24, in particular by way of the slicer, which adapts the CAD model accordingly. The control and/or regulation unit 20 may alternatively be designed to control and/or to regulate the printing head 18 during printing of the at least one dental device 12 so as to label the at least one dental device 12 through recesses on an outer side of the at least one dental device 12. It is possible to achieve advantageous labelling of the at least one dental device 12.

The printing parameter packages each comprise for example a filament type, a printing head type, a printing speed, a printing head temperature, a printing bed temperature, an air humidity and/or an alignment of a digital model of the dental device 12. The printing parameter package, depending on a required filament type for the model to be printed of at least one dental device 12, also in each case has a scaling factor for the model to be printed in at least one axis, which scaling factor is configured to compensate for a shrinkage behavior of the filament 16. The scaling factor is used to expand the model to be printed in relation to a CAD model in accordance with the at least one scaling factor in order to compensate for shrinkage of the printed model due to shrinkage of the filament 16. The scaling factor is used for shrinkage compensation. The scaling factor of the printing parameter package is adapted specifically to the filament 16 stored in the printing parameter package. The printing parameter package has a separate scaling factor in an X axis, a separate scaling factor in a Y axis and a separate scaling factor in a Z axis. The scaling factor in the X axis in this case corresponds to the scaling factor in the Y axis. By contrast, the scaling factor in the Z axis is lower than a scaling factor in the X axis and in the Y axis. The scaling factor is applied automatically via the printing parameter package in a printing operation. The scaling factor in this case ensures volumetric scaling.

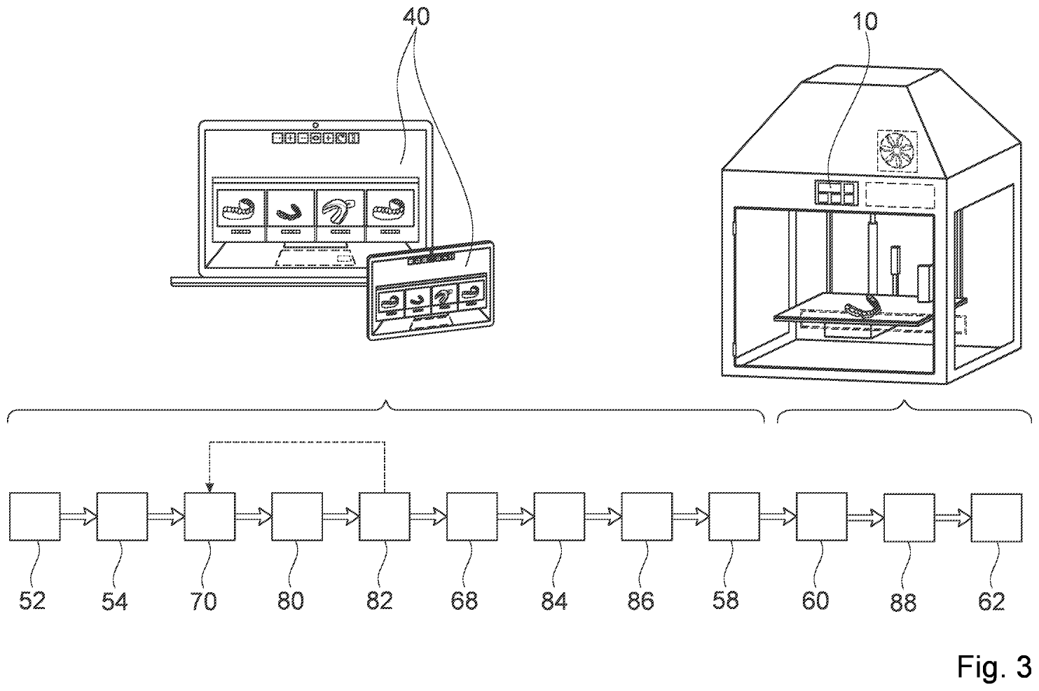

FIG. 3 shows a flowchart of a method for producing dental devices 12, in particular dental models, impression trays and/or aligners, by way of the dental printing system. The method describes the operation of the dental printing system according to the invention. The sequence in this case describes the printing process of a dental device 12 by way of example.

During the method, in a first reading-in step 52, a CAD file is read in on the operator terminal device 40 by the computing unit 24. The CAD file may for example be transmitted to the operator terminal device 40 from a server via a network or for example via a USB stick. Software is in particular executed on the operator terminal device 40 for operation. This is followed by a selection step 54, wherein, in the selection step 54, a printing parameter package designed for the printing of the dental device 12, in particular in the form of defined values for different printing parameters, is selected and applied by the computing unit 24 depending on a printing job. In the selection step 54, a user receives for selection, via the display unit 22, a graphical and/or visualized selection mask having for example three options for dental devices 12, in particular a dental model, an impression tray and an aligner. An operator is able to select, in the selection mask, which type of dental device 12 should be printed using the CAD file. With the selection of the dental device 12, the computing unit 24 loads one of the printing parameter packages stored on the memory unit 26 for printing the desired dental device 12 based on the user input. It is in particular also conceivable for the selection mask to be of multi-stage design and to have multiple selection levels, for example for different splints, such as aligners, bite trays or the like. It would additionally be conceivable for the selection mask to additionally contain selection options with regard to currently installed hardware. An operator may thus for example preselect which printing head is installed in the 3D filament printing apparatus 10 or which filament is currently inserted. This is followed by a checking step 70, in which the computing unit 24 checks the CAD file for errors and for optimizations. In the checking step 70, the CAD file is checked by way of the computing unit 24 for compliance with standard printing conditions, associated with the at least one dental device 12, for the 3D filament printing apparatus 10. A check is carried out in this case in particular depending on the user input, in particular depending on the selection of the dental device 12. It may for example already be checked in the checking step 70 whether the appropriate filament 16 is located in the filament reservoir unit 14 and whether there is enough filament 16 for the printing operation located in the filament reservoir unit 14. In the checking step 70, the computing unit 24 is used to check whether the model of the CAD file of the dental device 12 is closed or open. In the event of an open model, closure may for example be offered and/or the model is closed automatically. Also in the checking step 70, the computing unit 24 is used to check whether an alignment of the model to be printed of at least one dental device 12 corresponds to an alignment stored in the standard conditions for the at least one dental device 12. The computing unit 24 in this case checks whether an alignment of a largest base surface of the model to be printed corresponds to a subsequent resting surface on the printing plate 38. The computing unit 24 may in particular check whether the model to be printed actually has a resting surface on the printing plate 38 and whether the resting surface on the printing plate 38 corresponds to a base side configured for a printing operation. This is followed by an asking step 80 in which the errors determined in the checking step 70 are displayed to the operator and the operator is asked whether the errors should be rectified autonomously. In this case, the operator may in particular terminate or at least interrupt the printing operation and at least partially rectify the errors himself, or the operator confirms the automatic rectification of the errors by the computing unit 24. In the event of confirmation, the asking step 80 is followed by a correction step 82 in which the errors in the CAD file are rectified autonomously by the computing unit 24. Following this, the checking step 70 could optionally be repeated again, for example. It would also be conceivable, after a correction of the CAD file, for the computing unit 24 to propose a suggestion for a collision-free arrangement of the dental device 12 on the printing plate 38 to the operator. This may be expedient in particular when simultaneously printing multiple dental devices 12. It would be conceivable in this case in particular for the operator to be able to move the model on the printing plate 38 virtually only laterally and in a manner free from collision, and thus adapt an arrangement. However, a conversion step 68 is preferably carried out in response thereto, wherein, in the conversion step 68, a CAD file of the dental device 12 is converted into printing instructions by way of a computing unit 24. The CAD file is in this case converted into printing instructions by way of slicing software executed on the computing unit 24 in combination with the printing parameter package. After the conversion step 68, the printing instructions may possibly be checked again by the computing unit 24 in a further checking step 84. The printing instructions are checked for compatibility with the 3D filament printing apparatus 10 by way of the computing unit 24. This is followed by a further, in particular optional correction step 86. In the further correction step 86, the computing unit 24 corrects the printing instructions in the event of errors and/or compatibility problems. This is followed by a transmission step 58, wherein the printing instructions are transmitted to the 3D filament printing apparatus 10 in the transmission step 58. In the transmission step 58, the printing instructions are transmitted from the operator terminal device 40 to the 3D filament printing apparatus 10. The printing instructions are then read in by the 3D filament printing apparatus 10 in a further reading-in step 60. The printing instructions are then carried out in a printing step 62 and a desired dental device 12 is printed. During the printing step 62, a cleaning step 88 in particular takes place, in which the filament 16 is cleaned before a printing operation by way of the 3D filament printing apparatus 10. The 3D filament printing apparatus 10 to this end has an illustrated cleaning unit 90 that is arranged between the filament reservoir unit 14 and the printing head 18. The cleaning therefore takes place inline, by way of the cleaning unit 90 that is located upstream of the actual melting process and through which the filament 16 is conveyed during printing. The cleaning may take place using cleaning means and materials such as brushes or using scrubbing technology, for example in conjunction with appropriate suction technology and/or deionization in order to avoid electrostatic effects, which may promote the adhesion of dust. The cleaning unit 90 is integrated in the 3D filament printing apparatus 10, but may also be located upstream and be realized separately from the 3D filament printing apparatus 10.

### LIST OF REFERENCE SIGNS

10 3D filament printing apparatus

12 Dental device

14 Filament reservoir unit

16 Filament

18 Printing head

19 Extrusion nozzle

20 Control and/or regulation unit

22 Display unit

24 Computing unit

26 Memory unit

28 Operating unit

30 Housing unit

32 Infeed air slot

34 Filter element

36 Hood unit

38 Printing plate

40 Operator terminal device

42 Housing

44 Printing space

46 Door

48 Fan

50 Operator interface

52 Reading-in step

54 Selection step

58 Transmission step

60 Reading-in step

62 Printing step

64 Sensor unit

66 Air humidity and/or filament moisture sensor

68 Conversion step

70 Checking step

72 Stop sensor

74 Incorrect-printing sensor

76 Printing plate sensor

78 Fan sensor

80 Asking step

82 Correction step

84 Checking step

86 Correction step

88 Cleaning step

90 Cleaning unit

1. A dental printing system, having a 3D filament printing apparatus exclusively for printing dental devices, in particular dental models, impression trays and/or aligners, which 3D filament printing apparatus has a filament reservoir unit for receiving a filament, at least one printing head and a control and/or regulation unit, having a display unit and having a computing unit that is configured to convert a CAD file of the dental device into printing instructions and that comprises at least one memory unit, wherein the computing unit is configured, before each printing operation, to check the CAD file for compliance with standard printing conditions, associated with the at least one dental device, for the 3D filament printing apparatus.

2. The dental printing system according to claim 1, wherein the computing unit is configured, before each printing operation, to check the printing instructions for compliance with standard printing conditions, associated with the at least one dental device, for the 3D filament printing apparatus.

3. The dental printing system according to claim 1, wherein respectively one printing parameter package, in particular in the form of defined values for different printing parameters, is stored on the memory unit for the printing of each individual dental device, wherein the computing unit is configured to use a printing parameter package depending on a printing job.

4. The dental printing system according to claim 1, wherein the computing unit is designed, in the event of a recognized discrepancy between at least one parameter of the CAD file of at least one dental device and the standard printing conditions for the at least one dental device, to correct and/or to supplement the CAD file and/or to output a correction suggestion to an operator.

5. The dental printing system according to claim 1, wherein the computing unit is designed, in the event of a recognized discrepancy between at least one parameter of the CAD file and/or the printing instructions of at least one dental device and the standard printing conditions for the at least one dental device, to initiate a color change of the display unit.

6. The dental printing system according to claim 1, wherein the computing unit is designed to check the CAD file containing the digital model to be printed of the at least one dental device for data errors.

7. The dental printing system according to claim 1, wherein the computing unit is designed to check whether the CAD file of the at least one dental device is closed or open.

8. The dental printing system according to claim 1, wherein the computing unit is designed to check whether an alignment of the model to be printed of at least one dental device corresponds to an alignment stored in the standard conditions for the at least one dental device.

9. The dental printing system according to claim 1, wherein the computing unit is designed, in the event of a recognized discrepancy between the alignment of the model of at least one dental device and the standard printing conditions for the at least one dental device, to adapt the alignment of the model to the standard printing conditions.

10. The dental printing system according to claim 1, comprising an operating unit for operating the computing unit, wherein the computing unit is designed to load the printing parameter package for printing at least one desired dental device based on a user input.

11. The dental printing system according to claim 10, wherein the operating unit is realized separately from the 3D filament printing apparatus.

12. The dental printing system according to claim 1, wherein the computing unit is designed to load the printing parameter package for printing at least one desired dental device based on an, in particular graphical and/or visualized, selection mask in accordance with the at least one desired dental device in a digital model to be printed of the at least one dental device.

13. The dental printing system according to claim 1, wherein the control and/or regulation unit is designed to check whether a printing head required according to the printing parameter package, in particular a nozzle of the printing head, for the model to be printed of at least one dental device corresponds to the printing head that is used.

14. The dental printing system according to claim 1, wherein the 3D filament printing apparatus has a sensor unit that has at least one air humidity and/or filament moisture sensor that is connected to the control and/or regulation unit, wherein the at least one control and/or regulation unit is designed to check whether a measured humidity or moisture corresponds to a value of a predefined humidity or moisture.

15. The dental printing system according to claim 1, wherein the control and/or regulation unit is designed to output printing progress for at least one dental device via the display unit by way of a progress bar.

16. The dental printing system according to claim 1, comprising an operator terminal device that comprises the computing unit.

17. A 3D filament printing apparatus of a dental printing system according to claim 1.

18. A method for producing dental devices, in particular dental models, impression trays and/or aligners, in particular by way of a dental printing system according to claim 1, wherein, in at least one conversion step, a CAD file of the dental device is converted into printing instructions by way of a computing unit, wherein, in at least one transmission step, the printing instructions are transmitted to a 3D filament printing apparatus and wherein the printing instructions are carried out by way of the 3D filament printing apparatus in a printing step and a desired dental device is printed, wherein in at least one checking step, the CAD file is checked by way of the computing unit for compliance with standard printing conditions, associated with the at least one dental device, for the 3D filament printing apparatus.

19. The method according to claim 18, wherein in at least one selection step, a printing parameter package designed for the printing of the dental device, in particular in the form of defined values for different printing parameters, is selected and applied by the computing unit depending on a printing job.

20. The method according to claim 18, wherein the printing instructions are checked for compatibility with the 3D filament printing apparatus and/or for errors in a further checking step by way of the computing unit.

21. The method according to claim 18, comprising a cleaning step, in which the filament is cleaned before a printing operation by way of the 3D filament printing apparatus.
